(19) United States
(12) Patent Application Publication
(10) Pub. No.: US 2007/0279706 A1
(43) Pub. Date: Dec. 6, 2007

(54) Network scanner and image file sending method

(76) Inventor: Tatsuo Noda, Osaka (JP)

Correspondence Address: RABIN & Berdo, PC, 1101 14TH STREET, NW, SUITE 500, WASHINGTON, DC, 20005, US

(21) Appl. No.: 11/442,390

(22) Filed: May 30, 2006

(51) Int. Cl. H04N 1/04

(52) U.S. Cl. 358/474

(57) ABSTRACT

A network scanner 1 of the present invention has a scanner 3 for reading the manuscript image, an image storage 4 for storing the read manuscript image therein, an operation unit 5 operated by a user, a controller 2 for controlling the network scanner 1 and a network interface 6 for sending the prepared file to a designated destination. The file sending mode consists of the page mode of sending each page of the manuscript as a file and the total mode of sending all pages of the manuscript as one file. When the page mode is set, the file name containing the total number of pages of the manuscript is prepared.

### BACKGROUND OF THE INVENTION

1. Field of the Invention

The present invention relates to a network scanner for scanning a manuscript image, converting the scanned manuscript image into a file and sending the file to a designated personal computer or the like via a communication circuit.

2. Description of Related Arts

A network scanner for scanning a manuscript having a plurality of pages, converting the scanned manuscript into a file and sending image data to a personal computer connected to a network is publicly known. In such network scanner, prior to sending of the file, a file name is assigned to the scanned image data to prepare a manuscript image file. For example, when a file name of a transmission log in a device disclosed in Japanese Unexamined Patent Publication No. 2004-356849 is prepared, the file name that is easy to identify its content is assigned to the log so that a source of the data may be easily recognized only by referring to a folder name or the file name.

In a file name setting method in a device disclosed in Japanese Unexamined Patent Publication No. 2004-357241, a manuscript image read for each page is output and consecutive numbers corresponding to pages of the manuscript are assigned to a file name set by a user. The file name is assigned so that commonality of the image data in contents may be definitely recognized from the file name.

In the method disclosed in Japanese Unexamined Patent Publication No. 2004-357241, when the manuscript image read for each page is output, any accident may occur in sending the files to which the consecutive numbers are assigned. In this case, the files cannot be normally sent.

For example, providing that 10 files out of 20 are normally sent and then, an accident occurs in a network line and thus the 11th to the 20th files are not received by the personal computer. At this time, the 10 files having the file names to which numbers 1 to 10 are assigned are stored in the personal computer. Since abnormal sending cannot be recognized in the personal computer, the user may misunderstand that the files of 10 pages in total are normally sent.

### SUMMARY OF THE INVENTION

In consideration of this background, an object of the present invention is to provide a network scanner that can easily recognize any trouble in a network line by sent files.

According to the present invention, when a plurality of files to be sent in series are prepared in the network scanner, a file name containing a “number” representing the total number of files to be sent in series is prepared as the file name of at least a file to be initially sent. The file name containing the “number” is assigned to the first sending file.

Thereby, a person receiving the files can find the total number of files sent in series from the file name of the first received file. When the files of this number are not received, the user can easily recognize that a sending error occurs on the way.

### BRIEF DESCRIPTION OF THE DRAWINGS

FIG. 1 is a block diagram showing a configuration of an MFP as a network scanner in accordance with an embodiment of the present invention.

FIG. 2 is a view for describing an example of file names assigned to manuscript image files when a page mode is set.

FIG. 3 is a flow chart for describing an example of control operations of the MFP.

FIG. 4 is a view for describing another example of the file names assigned to the manuscript image files when the page mode is set.

FIG. 5 is a flow chart for describing another example of control operations of the MFP.

### DETAILED DESCRIPTION OF PREFERRED EMBODIMENTS

The following embodiment describes an example in which a multi-function machine for carrying out a lot of functions as an image processing device (hereinafter referred to as an MFP (Multi Function Peripheral) is used as a network scanner.

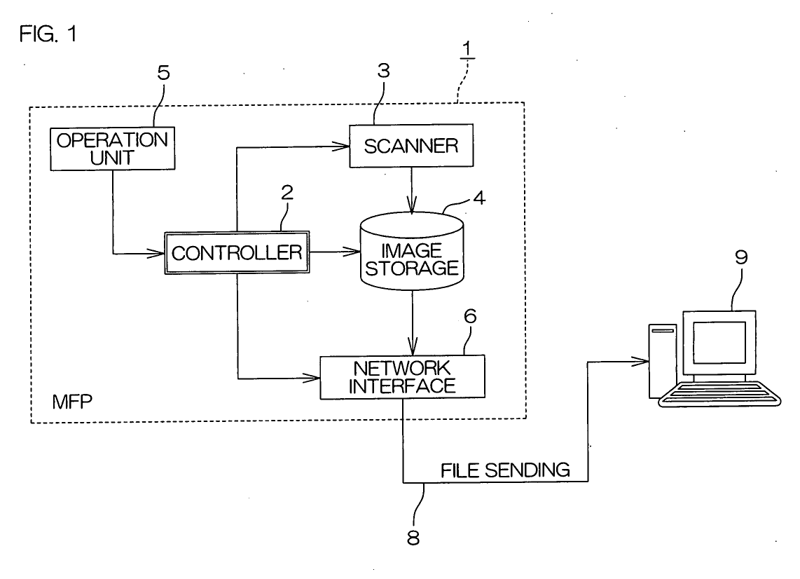

FIG. 1 is a block diagram showing a configuration of an MFP 1 in accordance with an embodiment of the present invention.

The MFP 1 includes a controller 2, a scanner 3, an image storage 4, an operation unit 5 and a network interface 6.

The operation unit 5 has a touch panel, a button or the like and the user operates the MFP 1 using the operation unit 5. With the operation unit 5, the user can set either a page mode of sending a manuscript image in each page of a manuscript read by the scanner 3 as a file or a total mode of sending images in all pages of the manuscript as one file, as a file sending mode.

The controller 2 has a CPU (not shown) as a control center for controlling the whole MFP 1 and a nonvolatile memory (not shown) that stores a control program for controlling the whole MFP 1 therein.

The scanner 3 reads the manuscript image and sends the read manuscript image data to the image storage 4.

The image storage 4 temporarily stores the manuscript image data therein. The manuscript image data stored in the image storage 4 is read according to an instruction of the controller 2. A file name corresponding to the file sending mode is assigned to the read manuscript image data and the manuscript image data, as a file, is sent from the network interface 6 to a personal computer 9 via a network line 8.

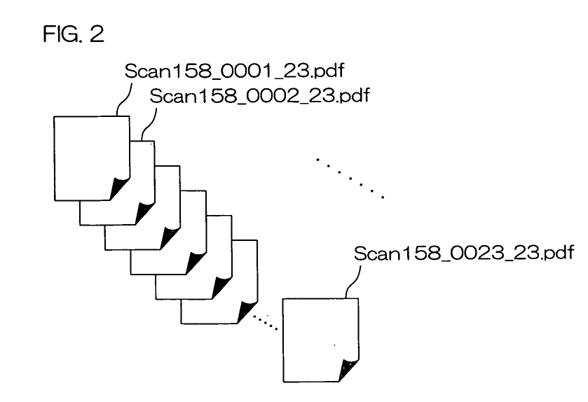

FIG. 2 is a view for describing the file names assigned to the manuscript image files when the page mode is set.

The controller 2, as a file preparing means, can convert the manuscript image data to be sent into a file and assign a file name to the file. As an example, the file name may have a unique name for identifying image data “Scan158”, a page number “0001”, “0002”, . . . or “0023”, the total number of pages and an extension representing a file format “pdf”.

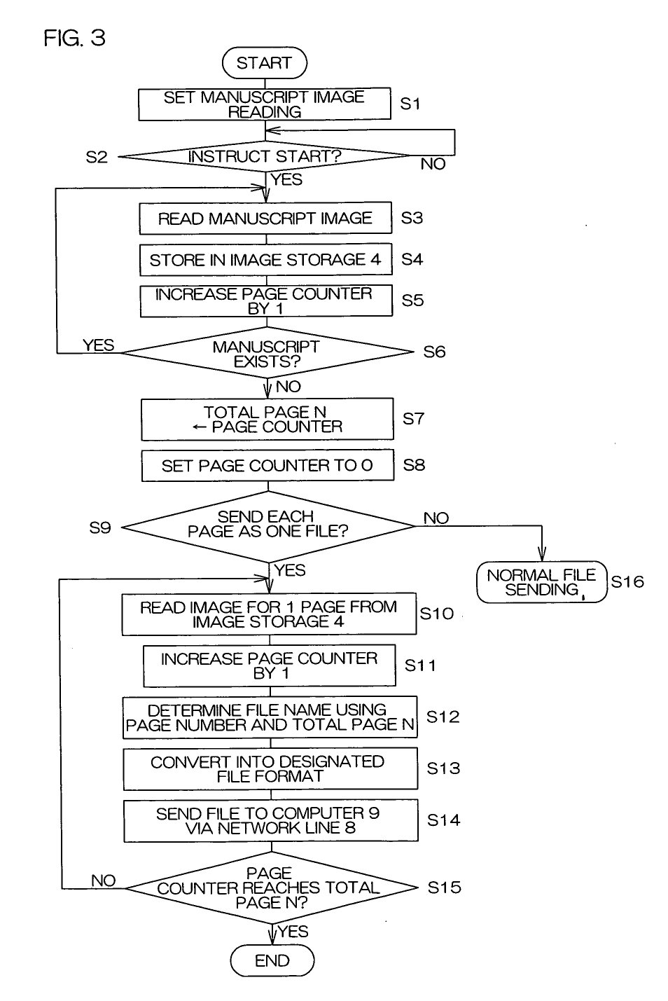

FIG. 3 is a flow chart for describing operations of the MFP 1 shown in FIG. 1. According to the flow in FIG. 3, the control operations for preparing the files in this embodiment will be described.

First, the controller 2 makes a setting for reading the manuscript image (step S1). The setting for image reading includes the setting of a file sending mode and a image reading mode. The file sending mode refers to the page mode of sending each page of the manuscript as a file or the total mode of sending all pages of the manuscript as one file.

Subsequently, the controller 2 determines whether or not a signal for instructing the start of image reading is input (step S2). When the start of image reading is instructed (Yes at the step S2), the procedure in the flow chart proceeds to a step S3.

Next, the controller 2 drives the scanner 3 to read a first page of the set manuscript (step S3) and the read manuscript image data is temporarily stored in the image storage 4 (step S4) The, a value of a page counter is increased by 1 (step S5).

Next, the controller 2 determines whether or not a next manuscript (the second page of the manuscript) set in the scanner 3 exists (step S6). When the next manuscript exists (Yes at a step S6), the procedure returns to the step S3 and allows the next page of the manuscript to be read by the scanner 3. The operations from the step S3 to the step S6 are repeated until the manuscript set in the scanner 3 runs out. The page counter at the step S5 counts the number of pages of the read manuscript.

When the manuscript set in the scanner 3 runs out (No at the step S6), the procedure proceeds to a step S7.

In this manner, in the example shown in FIG. 2, the manuscript images in the 1st to the 23rd pages are read sequentially by the scanner 3 and stored in the image storage 4.

Next, the controller 2 stores the value of the page counter as a total page N (step S7). In the example shown in FIG. 2, since the value of the page counter represents “23”, the number “23” is stored as the total page N. Then, the value of the page counter is set to “0” (step S8).

Subsequently, the controller 2 determines which of the page mode or the total mode is set (step S9). When the page mode is selected (Yes at the step S9), the procedure proceeds to a step S10.

The controller 2 reads the manuscript image data for one page from the image storage 4 (step S10) and the value of the page counter is increased by 1 (step S11). At this time, the page counter represents the page number of the manuscript image data read at the step S10. Then, the file name is prepared (step S12). At this time, in the example shown in FIG. 2, a file name “Scan158_{—}0001_{—}23.pdf” is prepared using the unique name “Scan158” for identifying the manuscript image data, the value of the page counter as the page number “0001”, the total page N “23” representing the total number of pages and the extension representing the file format “pdf”.

Next, the controller 2 converts the manuscript image data read at the step S10 into the manuscript image file in a designated file format (step S13) and assigns the file name “Scan158_{—}0001_{—}23.pdf” prepared at the step S12 to the file. Then, the manuscript image file to which “Scan158_{—}0001_{—}23.pdf” is assigned is sent to the personal computer 9 as a designated destination via the network interface 6 and the network line 8 (step S14)

Next, the controller 2 determines whether or not the value of the page counter is equal to the value of the value of the total page N “23” (step S15). In the initial state, since the value of the page counter is “1” and does not reach the total page N (No at the step S15), the procedure returns to the step S10.

Then, the controller 2 performs the operations at the steps S10 to S15 until the value of the page counter reaches the total page N. In the example shown in FIG. 2, since the value of the page counter “22” does not reach the value of the total page N “23” at the 22nd repeat of the step S15, the procedure in the flow chart returns to the 23rd repeat of the step S10. Until this time, the manuscript image files having the file names “Scan158_{—}0001_{—}23.pdf” to “Scan158_{—}0022_{—}23.pdf” have been sequentially sent to the personal computer 9.

Next, the controller 2 reads the manuscript image data for one page from the image storage 4 (step S10) and the value of the page counter is increased by 1 (step S11). At this time, the value of the page counter becomes “23” presenting the page number of the manuscript image data read at the step S10. Then, the file name “Scan158_{—}0023_{—}23.pdf” is prepared (step S12).

Next, the controller 2 converts the manuscript image data read at the step S10 into the manuscript image file in the designated file format (step S13) and the file name “Scan158_{—}0023_{—}23.pdf” prepared at the step S12 is assigned to the file. The manuscript image file to which the file name “Scan158_{—}0023_{—}23.pdf” is assigned is sent to the personal computer 9 as the designated destination via the network interface 6 and the network line 8 (step S14).

Next, the controller 2 determines whether or not the value of the page counter is equal to the total page N “23” (step S15). Since the value of the page counter becomes “23” and reaches the total page N (Yes at the step S15), the procedure in the flow chart is finished.

On the other hand, determination is made that the total mode is selected at the step S9 (No at the step S9), all of the read manuscript image data is converted into one manuscript image file and the file is sent to the personal computer 9 via the network interface 6 and the network line 8 (step S16).

Providing that due to trouble of the network line or the like, the manuscript image files having certain page numbers among a series of the page numbers, for example, the file of “Scan158_{—}011_{—}23.pdf” and succeeding files have not reached. At this time, the user can easily recognize the total number of pages of the manuscript read in the MFP 1 is “23” from the file name among the plurality of files sent to the personal computer 9 (for example, “Scan158_{—}0010_{—}23.pdf”). Furthermore, since the files having the file names “Scan158_{—}0001_{—}23.pdf” to “Scan158_{—}0010_{—}023.pdf” are sent to and stored in the personal computer 9, it can be easily judged that the files of the 11th and succeeding pages afterwards cannot be sent due to some sort of trouble. Thus, when a part of the manuscript image files cannot be sent to the personal computer 9 due to trouble of the network line 8 or the like, the user can easily determine whether or not the files are normally sent by checking the prepared file name based on the page number and the total number of pages of the manuscript image file. Furthermore, the user can easily recognize the page number of the file that cannot be received by checking the file name. If necessary, the user can also make an operation to send the remaining files that are not sent.

In the above-mentioned example, “Scan158” is used as the file name. However, a character string desirable to the user (for example, “ABC123”) may be set. Using this “ABC123”, the controller 2 can prepare a file name such as “ABC123_{—}0001_{—}23.pdf”. Since the manuscript image file of the desirable file name can be obtained when the manuscript image file is sent from the MFP 1 to the personal computer 9 and stored therein, the user can save time and effort to change the file name to a desirable one after receiving the file at the personal computer 9.

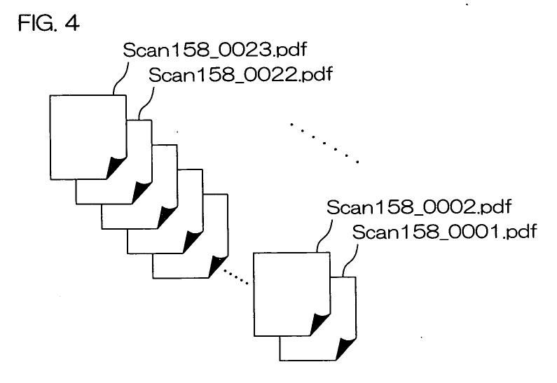

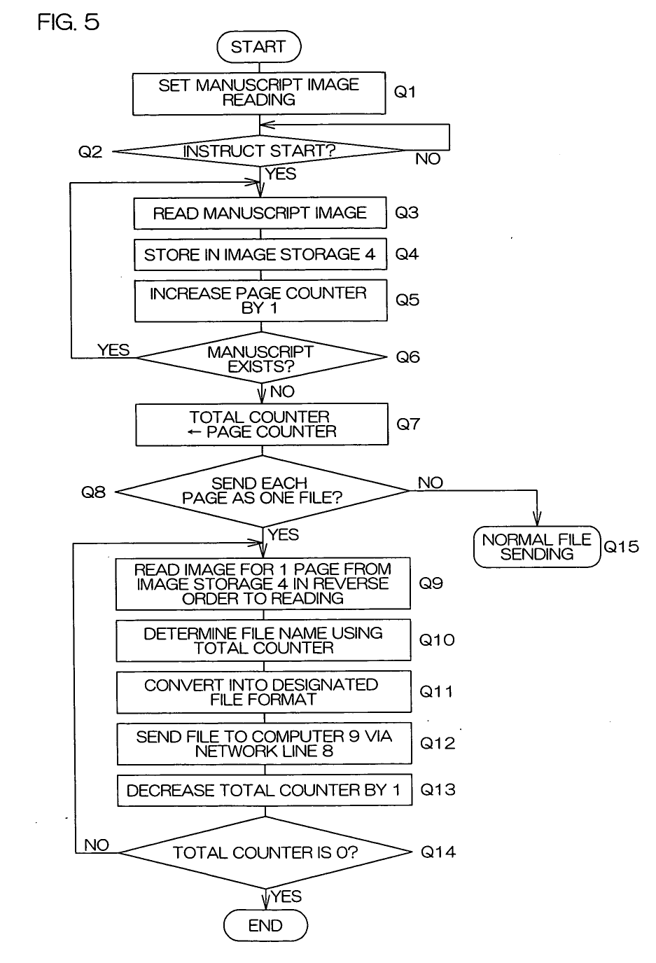

Next, with reference to FIG. 4 and FIG. 5, another embodiment will be described.

FIG. 4 is a view for describing the file names assigned to the manuscript image files when the page mode is selected.

The controller 2, as a file preparing means, can convert the manuscript image data to be sent into a file and assign a file name to the file. As an example, the file name may consist of a unique name for identifying image data “Scan158”, a page number “0023”, “0022”, . . . “0002” or “0001” and an extension representing a file format “pdf”.

FIG. 5 is a flow chart showing control operations of the MFP 1 in another embodiment.

In the flow chart shown in FIG. 5, steps Q1 to Q6 are the same as the steps S1 to S6 in the control contents.

In the example as shown in FIG. 4, by performing the steps Q1 to Q6, manuscript images in the 1st to 23rd pages are sequentially read by the scanner 3 and the read images are stored in the image storage 4.

Next, the controller 2 stores the value of the page counter in a total counter (step Q7). In the example as shown in FIG. 4, since the value of the page counter is “23”, the number “23” is stored in the total counter. The value of the total counter represents the number of the manuscript image data stored in the image storage 4.

Next, the controller 2 determines which of the page mode or the total mode is selected (step Q8). When the page mode is selected (Yes at the step Q8), the procedure proceeds to the step Q9.

The controller 2 read out the manuscript image data in the 1st page from the image storage 4 in the reverse order to that in reading-in (step Q9). Based on the value of the total counter, the file name is decided (step Q10). In the example shown in FIG. 4, the value of the total counter at this time is “23”. Thus, the file name is prepared using the value of the total counter “23”. Specifically, the file name “Scan158_{—}0023.pdf” is prepared using a unique name for identifying manuscript image data “Scan158”, the value of the total counter “0023” as a page number and an extension representing a file format “pdf”.

Next, the controller 2 converts the manuscript image data read at the step Q9 into the manuscript image file in the designated file format (step Q11) and the file name “Scan158_{—}0023.pdf” prepared at the step Q10 is assigned to the file. The manuscript image file to which the file name “Scan158_{—}0023.pdf” is assigned is sent to the personal computer 9 as the designated destination via the network interface 6 and the network line 8 (step Q12).

Next, the controller 2 decreases the value of the total counter by 1 (step Q13). In the example shown in FIG. 4, the value of the total counter is changed from “23” to “22” at the step Q13. Then, the controller 2 determines whether or not the value of the total counter is equal to “0” (step Q14). Since the value of the total counter “22” at this time is not “0” (No at the step Q14) the procedure returns to the step Q9.

The controller 2 repeats the operations at the steps Q9 to Q14 until the value of the total counter becomes “0” and when the value of the total counter becomes “0”, the procedure is finished.

On the other hand, determination is made that the total mode is selected at the step Q8 (No at the step Q8), all of the read manuscript image data is converted into one manuscript image file and the file is sent to the personal computer 9 via the network interface 6 and the network line 8 (step Q15).

Providing that due to trouble of the network line or the like, the manuscript image files having certain page numbers among a series of the page numbers, for example, the 14th file “Scan158_{—}0010.pdf” to the final file “Scan158_{—}0001.pdf” have not reached. At this time, since the files having the file names “Scan158_{—}0023.pdf ” to “Scan158_{—}0011.pdf” are sent to and stored in the personal computer 9 in the sending order, the user can easily recognize that 23 files in total beginning from the first received file having the file name “Scan158_{—}0023.pdf” have been sent. Furthermore, the user can easily determine that the 14th and succeeding files afterwards cannot be stored for any accident. Thus, when the files having continuous numbers from the last page number to the page number “1” are not stored, the user can readily judge that trouble of the network line or the like has occurred. Moreover, the user can easily recognize which page number of the file is not received by checking the file names of the files stored in the personal computer 9. If necessary, the user can make an operation to send the remaining files that are not received.

In the above-mentioned descriptions, the file preparing processing is performed in the main unit of the MFP 1 by using the operation unit 5 provided in the MFP 1. However, in place of this, the personal computer 9 connected to the network line 8 can give the above-mentioned instruction for image reading.

In this case, the “Set manuscript image reading” at the steps S1 and Q1 and the “Instruct start” at the steps S2 and Q2 in the flow charts shown in FIGS. 3 and 5 are performed according to a signal sent from the personal computer 9 to the MFP 1 via the network line 8 and the network interface 6.

Although the unique file name at its preparation is set in the MFP 1, the file name may be set on a setting screen of a MFP driver of the personal computer 9.

The other various modifications in design can be made as long as it falls within the scope defined in claims.

Embodiments of the present invention have been discussed in detail, but these embodiments are mere specific examples for clarifying the technical contents of the present invention. Therefore, the present invention should not be construed as limited to these specific examples. The spirit and scope of the present invention are limited only by the appended claims.

What is claimed is:

1. A network scanner for scanning a manuscript image, converting the scanned manuscript image into a file and sending the file to a designated personal computer or the like via a communication circuit comprising:
a scanner for scanning an image of a manuscript;
an image storage for storing the manuscript image scanned by the scanner;
a mode determining unit arranged to determine which of a page mode of sending the manuscript image in each page of the manuscript scanned by the scanner as a file or a total mode of sending manuscript images in all pages of the manuscript as one file is set;
a file name preparing unit arranged to prepare a file name containing the total number of files sent in series as the file name of at least the initially sent file based on that said mode determining unit determines that the page mode is set;
a file preparing unit arranged to prepare a file having the file name prepared by the file preparing unit; and
a sending unit arranged to send the prepared file to a designated destination.

2. A network scanner as stated in claim 1, wherein
when the file name is prepared for each page of the manuscript, the file name preparing unit prepares the file name containing the total number of pages of the manuscript.

3. A network scanner as stated in claim 2, wherein
the file name preparing unit prepares the file name containing a unique name, a page number and the total number of pages.

4. A network scanner as stated in claim 1, wherein
the file name preparing unit prepares files by reading the manuscript image by each page from the image storage in the order reverse to that in scanning and assigning the file names containing numerical values decreased from the last page toward the first page by 1 to the files.

5. A network scanner as stated in claim 4, wherein
the file name preparing unit prepares the file name having a unique name and a decremented page number.

6. An image file sending method for scanning manuscript images by a network scanner and sending image files via a communication circuit comprising steps of:
converting the scanned manuscript images into a plurality of files;
assigning a file name to each file, the file name containing the total number of files to be sent in series as the file name of at least the file initially sent; and
sequentially sending the files having the assigned file names.
